(19) United States
(12) Patent Application Publication
(10) Pub. No.: US 2006/0008614 A1
(43) Pub. Date: Jan. 12, 2006

(54) Die cut mesh material from polymer fiber

(76) Inventors: Anthony L. Rockwell, Pickerington, OH (US); James R. Hand, Fairview, TN (US)

Correspondence Address: OWENS CORNING, 2790 COLUMBUS ROAD, GRANVILLE, OH, 43023, US

(21) Appl. No.: 10/889,442

(22) Filed: Jul. 12, 2004

(51) Int. Cl. B32B 3/12

(52) U.S. Cl. 428/116; 428/117

(57) ABSTRACT

A honeycomb web precursor includes a body of polymer material having a series of branched slits. The body is capable of expanding into a web of honeycomb construction. Various panels and partitions are also disclosed. A method is also provided for producing a honeycomb web of polymer material. That method includes the making of a series of branched slits in a body of polymer material so as to define multiple expansion ribs and the expanding of the body and erecting of the expansion ribs by folding so as to form the honeycomb web.

### TECHNICAL FIELD AND INDUSTRIAL APPLICABILITY OF THE INVENTION

The present invention relates generally to a honeycomb web precursor as well as a method of producing a honeycomb web of polymer material. More specifically, the present invention also relates to a partition and a panel comprising a honeycomb web of polymer material including a series of geometric shaped openings.

### BACKGROUND OF THE INVENTION

Perforated nonwoven fabrics of polymer material are well known in the art. Representative examples include U.S. Pat. No. 5,714,107 to Levy et al.; U.S. Pat. No. 4,615,671 to Bernal and U.S. Pat. No. 3,864,198 to Jackson. In each of these prior art patents the polymer material is slit or cut and then subjected to stretching to provide a honeycomb web or open cell structure.

Unfortunately, the stretching of the material to open the honeycomb or cellular structure leads to the tearing of a significant number of the fiber to fiber bonds thereby reducing the strength and integrity of the resulting material. Further, the friability of the material is also increased by the tearing of so many bonds. Thus, erection of the honeycomb web or cellular material in accordance with prior art methods leads to two significant detrimental results.

The present invention relates to a honeycomb web precursor and a method of producing a honeycomb web of polymer material wherein the precursor is erected by folding rather than stretching. Accordingly, the resulting product has improved fiber to fiber bond integrity and exhibits reduced friability when compared to prior art cellular structures.

### SUMMARY OF THE INVENTION

In accordance with the purposes of the present invention as described herein, a honeycomb web precursor is provided. The honeycomb web precursor comprises a body of polymer material including a series of branched slits. Advantageously, the body is capable of being expanded into a web or honeycomb construction primarily by folding rather than stretching.

More specifically describing the invention the polymer material includes thermoplastic fibers, thermosetting fibers or both thermoplastic include bicomponent fibers. In accordance with one aspect of the present invention the polymer material may be selected from a group consisting of polyolefin, polyester, polypropylene, polyethylene, nylon, rayon, polyethylene terephthalate, polybutylene terephthalate and mixtures thereof.

Further, the polymer material may include reinforcing fibers. Those reinforcing fibers may be selected from a group consisting of glass fibers, metal fibers, mineral fibers, carbon fibers, graphite fibers, natural fibers and mixtures thereof. The reinforcing fibers may have diameters of between about 5 and 50 microns and a length of between about 12.6 and 75.6 mm.

Still further, the body includes a first portion and a second portion. The first portion is substantially continuous and the second portion includes the series of branched slits. In one embodiment, the first and second portions alternate across the body.

Still more specifically describing the invention, the series of branched slits at least partially nest with one another. In one possible embodiment, each of the branched slits is substantially Y-shaped. Adjacent branched slits also define an expansion rib. Each expansion rib includes a first segment and a second segment. The first segment is connected to the second segment by a first living hinge. The first segment is connected to one of the first portions by a second living hinge and the second segment is connected to another of the first portions by a third living hinge.

In accordance with another aspect of the present invention, a honeycomb web precursor is provided comprising a body of polymer material including alternating rows of (a) straight slits and (b) openings with extension slits defining a four-way living hinge at a convergence of adjacent straight slits and the openings.

In accordance with yet another aspect of the present invention, a method is provided for producing a honeycomb web of polymer material. That method comprises the steps of making a series of branched slits in a body of polymer material so as to define multiple expansion ribs and expanding that body and erecting the expansion ribs so as to form the honeycomb web. Still further, the method includes the step of setting the honeycomb web in an expanded condition. This may include thermally setting the polymer material. Setting may include connecting the body in the expanded condition to a facing material. Further, the method includes optionally filling openings in the honeycomb material with another material having desired thermal insulating, acoustical insulating and/or structural properties. As indicated above, the expanding or erecting of the honeycomb web is achieved by folding, not stretching the body. Accordingly, the integrity of fiber to fiber bonds is maintained for maximum material strength and the friability of the resulting erected structure is minimized.

In accordance with a more specific aspect of the present invention, a motor vehicle panel comprising a honeycomb web of polymer material including a series of geometric shaped openings is provided. In accordance with yet another more specific aspect of the present invention, a partition is provided comprising a honeycomb web of polymer material including a series of geometric shaped opening sandwiched between a first decorative face and a second decorative face. In accordance with yet another aspect of the present invention, a panel is provided comprising a layer constructed from a honeycomb web of polymer material. That layer has a first face and a second face. A first facing layer is connected to the first face. The first facing layer is constructed from a material selected from a group consisting of polymer facings, foils, paper type facings, fiberglass reinforced mats, EVA (ester vinyl acetate), rubber materials and highly filled layers of material around a reinforced web as well as mixtures thereof. Additionally, the panel may include a second facing layer connected to the second face. That second facing layer is constructed from materials similar to those of the first facing layer.

### BRIEF DESCRIPTION OF THE DRAWINGS

The accompanying drawings incorporated in and forming a part of the specification, illustrate several aspects of the present invention and together with the description serve to explain certain principles of the invention. In the drawings:

FIGS. 1a and 1b are top plan views respectively illustrating a first embodiment of the honeycomb web precursor and the folded or erected honeycomb web of a first embodiment of the present invention;

FIGS. 2a and 2b are top plan views illustrating, respectively, an unerected honeycomb web precursor and an erected honeycomb web of a second embodiment of the present invention;

FIG. 3 is a cross sectional view illustrating another possible embodiment of the present invention wherein the spaces, openings or cells of the web material are filled with a material selected for its insulating or other properties;

FIG. 4 is yet another embodiment of the present invention wherein the honeycomb web includes a first facing layer;

FIG. 5 is a schematical side elevational view illustrating the inline processing of the honeycomb web precursor of the present invention; and

FIG. 6 is yet another alternative embodiment wherein the honeycomb web includes opposing facing layers.

Reference will now be made in detail to the present preferred embodiment of the invention, an example of which is illustrated in the accompanying drawings.

### DETAILED DESCRIPTION AND PREFERRED EMBODIMENTS OF THE INVENTION

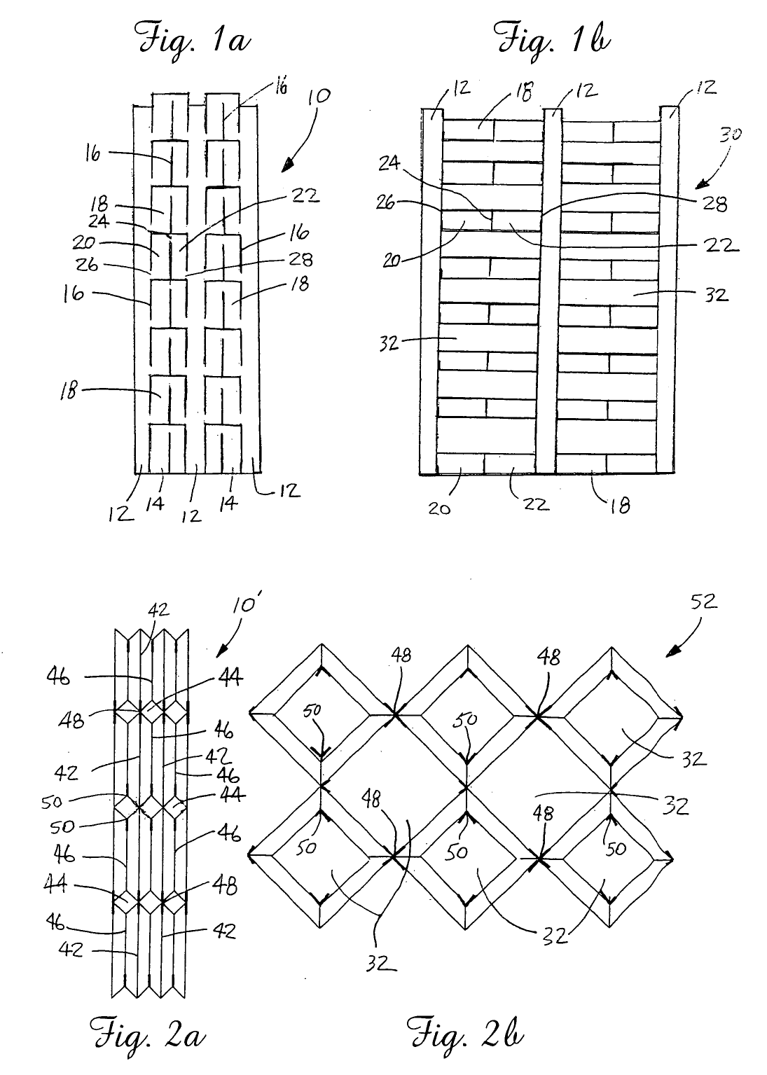

Reference is now made to FIG. 1a showing a honeycomb web precursor 10 of the present invention. The honeycomb web precursor 10 is formed from a body of polymer material such as a thermoplastic non-woven material. Materials useful for the intended purpose include but are not limited to thermoplastic fibers, thermosetting fibers and mixtures of thermoplastic and thermosetting fibers. Bicomponent fibers may also be utilized. Exemplary of specific materials that may be utilized to construct the body are polyolefin, polypropylene, polyethylene, polyester, nylon, rayon, polyethylene terephthalate, polybutylene terephthalate and any mixtures thereof. Of course, still other materials may be used. The material may also incorporate reinforcing fibers such as glass fibers, metal fibers, natural fibers, mineral fibers, graphite fibers, carbon fibers and the like. Typical reinforcing fibers have a diameter between about 5 and 50 microns and a length between about 12.6 and 75.6 mm.

As illustrated in FIG. 1a, the honeycomb web precursor 10 includes alternating first portions 12 and second portions 14. The first portions are substantially continuous, elongated strips while the second portions include a series of branched slits 16 that extend completely through the body of the precursor 10. As illustrated each branched slit is substantially Y shaped and the series of branched slits at least partially nest with one another.

As further illustrated in FIGS. 1a and 1b, adjacent branched slits 16 define an expansion rib 18. Each expansion rib 18 includes a first segment 20 and a second segment 22. The first segment 20 is connected end-to-end with the second segment 22 by a first living hinge 24. The opposite end of the first segment 20 is connected to a first portion 12 of the precursor 10 by a second living hinge 26. Similarly, a third living hinge 28 connects the opposite end of the second segment 22 to another, different first portion 12.

FIG. 1b shows the expanding of the body of the honeycomb web precursor 10 and the erecting of the expansion ribs 18 so as to form the honeycomb web 30. More specifically, each of the expansion ribs 18 is folded along the first, second and third living hinges 24, 26, 28 so that the first portions 12 are separated and the expansion ribs are erected to extend straight between adjacent first portions 12. As a result, a series of open cells 32 are provided between adjacent expansion ribs 18 and first portions 12. Depending upon the size of the branched slits 16 provided in the second portions 14 of the honeycomb web precursor 10, the area covered by the geometric pattern of the erected honeycomb web 30 compared to the original area of the honeycomb web precursor 10 can be an increase of perhaps 150 to 500%.

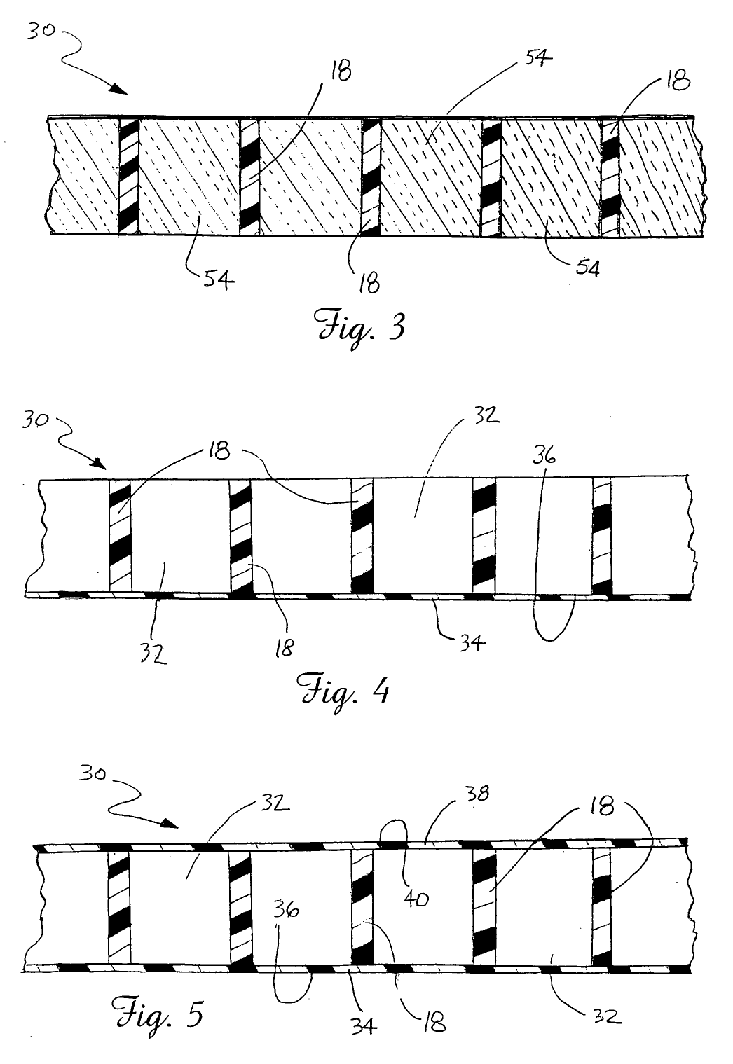

The honeycomb web 30 may be set in the erected condition in one of two ways. In the first the erected honeycomb web 30 is heat treated above the thermoplastic and/or thermosetting fiber melt temperature and then cooled in order to thermally set the polymer material in the erected shape. Alternatively or in addition, a facing layer 34 may be adhered to a first face 36 of the erected honeycomb web 30 (see FIG. 4 embodiment). In yet another embodiment, a second facing layer 38 may be adhered to a second facing 40 of the erected honeycomb web 30 (see FIG. 5 embodiment). In either of the FIG. 4 and FIG. 5 embodiments, the facing layers 34, 38 are sufficiently rigid to hold the expansion ribs 18 in the expanded or erected condition thereby maintaining the cells 32 of the honeycomb web 30 in a fully expanded condition. The first and second facing layers 34, 38 may be constructed from a number of materials including but not limited to polymer facings, foils, paper type facings, fiberglass reinforced mats, EVA (ester vinyl acetate), rubber materials and highly filled layers of material around a reinforced web as well as mixtures thereof.

Yet another alternative embodiment is illustrated in FIGS. 2a and 2b. In this embodiment, the honeycomb web precursor 10′ again comprises a body of polymer material. That material may include thermoplastic fibers, thermosetting fibers or a mixture of both thermoplastic and thermosetting polymer fibers. Further the polymer material may include bicomponent fibers. As in the FIG. 1a embodiment the polymer material may be selected from a group consisting of polyolefin, polyester, polypropylene, polyethylene, nylon, rayon, polyethylene terephthalate, polybutylene terephthalate and mixtures thereof. Further the polymer material may include reinforcing fibers that may be selected from a group consisting of glass fibers, natural fibers, metal fibers, mineral fibers, carbon fibers, graphite fibers and mixtures thereof.

In this embodiment of the invention the branched slits 16 of the FIG. 1a embodiment are replaced with alternating rows of (a) straight slits 42 and (b) openings 44 with extension slits 46 defining a four-way living hinge 48 at a convergence of adjacent straight slits and openings.

As with the FIG. 1a embodiment, the FIG. 2a embodiment is erected by folding the honeycomb web precursor 10′ about the four-way living hinges 48 provided at the convergence of adjacent straight slits 42 and openings 44 and the additional living hinges 50 provided at opposing corners of alternating openings 44 that do not define four-way living hinges 48.

The erected honeycomb web 52 of the second embodiment is illustrated in FIG. 2b. As with the earlier embodiment the honeycomb web 52 may be held in the erected position by thermally setting the material and/or adding one or two facing layers.

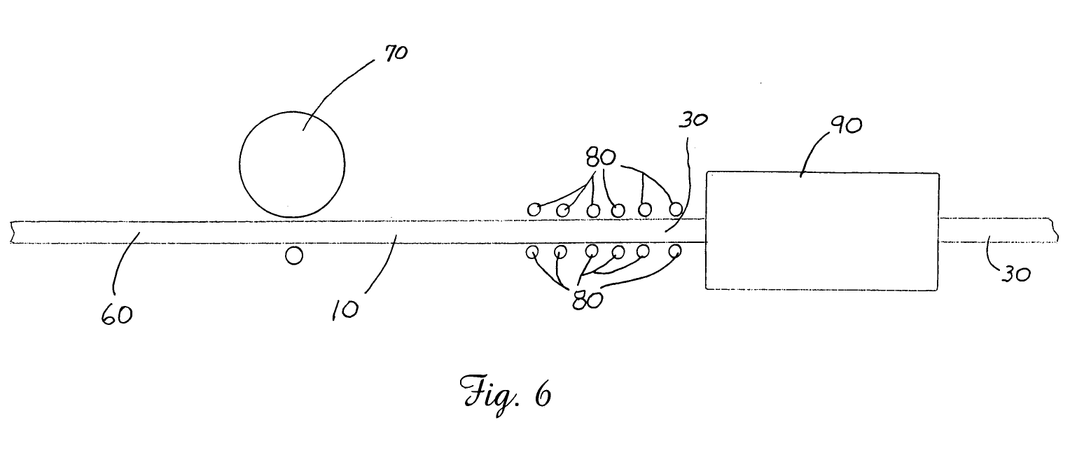

The in-line production of the honeycomb web precursor 10 and erected honeycomb web 30 of the present invention is schematically illustrated in FIG. 6.

The body of polymer material 60 is fed from a roll or directly from a forming station through the rotary die cutter 70 that cuts the nested, branched slits 16 in the second portions of the precursor 10. The precursor 10 is then advanced through a series of spreader rolls 80 that expand the precursor by folding the expansion ribs 18 open about the hinges 24, 26, 28. Next, the honeycomb web 30 is advanced through a setting device 90 so that it will hold its shape. That setting device may be a thermal oven or a facing applicator. Of course, it should be appreciated that the production line may include a station to introduce material into the open cells 32 of the web 30 if desired for a particular product application.

In any embodiment of the present invention, the open cells 32 may simply function as air spaces. Alternatively, the open cells 32 may be partially or completely filled with any material that exhibits desired properties or characteristics. For example, the cells 32 may be filled with polymer material 54 of any type that exhibits desired acoustical insulating and/or thermally insulating properties and/or structural reinforcing properties (see FIG. 3 embodiment). Of course, this material 54 may be sealed in the cells 32 by providing a facing layer 34, 38 over each face 36, 40 of the honeycomb web 30, 52 (see embodiments of FIGS. 4 and 5).

The honeycomb web 30, 52 of the present invention has a myriad of potential applications including as a motor vehicle panel, a partition such as a room partition or other structural panel such as a building panel. The honeycomb web 30, 52 may be used as an acoustical decoupler, or as a stiffener. The process and product may be utilized to reduce material in constructing a panel, partition or the like. This reduces both the production costs and the weight of the final product without any significant compromise in product strength.

The honeycomb web 30, 52 may also be useful as a thermal insulator. Some potential applications in the automotive industry include but are not limited to under carpet applications, heat shields, acoustical decouplers for engine sides and interior materials and as a filler material. Some potential non-automotive applications for the honeycomb web 30, 52 include the appliance industry, where the material may be used as a dishwasher blanket, clothes washer insulator and clothes dryer insulator, and as acoustical filler materials for wall panels and ceiling tiles.

The foregoing description of the preferred embodiment of the invention has been presented for purposes of illustration and description. It is not intended to be exhaustive or to limit the invention to the precise form disclosed. Obvious modifications or variations are possible in light of the above teachings. For example, while a rotary die cutter 65 is described and illustrated for cutting the branched slits 16, other devices/methods could be utilized. These include but are not limited to cutting by water jet, laser and/or die rule.

The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiment do not and are not intended to limit the ordinary meaning of the claims and their fair and broad interpretation in any way.

What is claimed:

1. A honeycomb web precursor, comprising:
a body of polymer material including a series of branched slits, said body being capable of expanding into a web or honeycomb construction.

2. The honeycomb web precursor of claim 1 wherein said polymer material includes thermoplastic fibers.

3. The honeycomb web precursor of claim 1, wherein said polymer material includes thermosetting fibers.

4. The honeycomb web precursor of claim 1, wherein said polymer material includes both thermoplastic and thermosetting polymer fibers.

5. The honeycomb web precursor of claim 1, wherein said polymer material includes bicomponent fibers.

6. The honeycomb web precursor of claim 1, wherein said polymer material is selected from a group consisting of polyolefin, polyester, polypropylene, polyethylene, nylon, rayon, polyethylene terephthalate, polybutylene terephthalate and mixtures thereof.

7. The honeycomb web precursor of claim 6, wherein said polymer material includes reinforcing fibers selected from a group consisting of glass fibers, metal fibers, mineral fibers, carbon fibers, graphite fibers, natural fibers and mixtures thereof.

8. The honeycomb web precursor of claim 1, wherein said polymer material includes reinforcing fibers selected from a group consisting of glass fibers, natural fibers, metal fibers, mineral fibers, carbon fibers, graphite fibers and mixtures thereof.

9. The honeycomb web precursor of claim 8, wherein said reinforcing fibers have a diameter of between about 5 and 50 microns and a length of between about 12.6 and about 75.6 mm.

10. The honeycomb web precursor of claim 1, wherein said body includes a first portion and a second portion, said first portion being substantially continuous and said second portion including said series of branched slits.

11. The honeycomb web precursor of claim 1, wherein said body includes alternating first portions and second portions, said first portions being substantially continuous and said second portions including said series of branched slits.

12. The honeycomb web precursor of claim 11, wherein said series of branched slits at least partially nest with one another.

13. The honeycomb web precursor of claim 12, wherein each of said branched slits is substantially Y shaped.

14. The honeycomb web precursor of claim 13, wherein adjacent branched slits define an expansion rib.

15. The honeycomb web precursor of claim 14, wherein each expansion rib includes a first segment and a second segment, said first segment being connected to said second segment by a first living hinge, said first segment being connected to one of said first portions by a second living hinge and said second segment being connected to another of said first portions by a third living hinge.

16. The honeycomb web precursor of claim 1, wherein each of said branched slits is substantially Y shaped.

17. The honeycomb web precursor of claim 16, wherein adjacent branched slits define an expansion rib.

18. The honeycomb web precursor of claim 17, wherein each expansion rib includes a first segment and a second segment, said first segment being connected to said second segment by a first living hinge, said first segment being connected to one of said first portions by a second living hinge and said second segment being connected to another of said first portions by a third living hinge.

19. A honeycomb web precursor, comprising:
a body of polymer material including alternating rows of (a) straight slits and (b) openings with extension slits defining a four-way living hinge at a convergence of adjacent straight slits and said openings.

20. A method for producing a honeycomb web of polymer material, comprising:
making a series of branched slits in a body of polymer material so as to define multiple expansion ribs; and
expanding said body and erecting said expansion ribs so as to form said honeycomb web.

21. The method of claim 20 further including setting said honeycomb web in an expanded condition.

22. The method of claim 21 wherein said setting step includes thermally setting said polymer material.

23. The method of claim 22, wherein said setting step includes connecting said body in said expanded condition to a facing material.

24. The method of claim 23, further including filling openings in said honeycomb web with another material having desired thermal insulating, acoustical insulating or structural properties.

25. The method of claim 20 wherein said expanding and erecting is achieved by folding said body so as to minimize or eliminate stretching.

26. A motor vehicle panel, comprising a honeycomb web of polymer material including a series of geometric shaped openings.

27. The panel of claim 26 wherein said honeycomb web includes a first face and a second face wherein said first and second faces are opposing and said geometric shaped openings extend between and through said first and second faces.

28. The panel of claim 27, wherein said polymer material is selected from a group consisting of polyolefin, polyester, polypropylene, polyethylene, nylon, rayon, polyethylene terephthalate, polybutylene terephthalate and mixtures thereof.

29. The panel of claim 28, wherein said polymer material further includes reinforcing fibers selected from a group consisting of glass fibers, natural fibers, metal fibers, mineral fibers, carbon fibers, graphite fibers and mixtures thereof.

30. A partition, comprising:
a honeycomb web of polymer material including a series of geometric shaped openings sandwiched between a first decorative face and a second decorative face.

31. The partition of claim 30 wherein said honeycomb web includes a first face and a second face wherein said first and second faces are opposing and said geometric shaped openings extend between and through said first and second faces.

32. The partition of claim 31, wherein said polymer material is selected from a group consisting of polyolefin, polyester, polypropylene, polyethylene, nylon, rayon, polyethylene terephthalate, polybutylene terephthalate and mixtures thereof.

33. The partition of claim 32, wherein said polymer material further includes reinforcing fibers selected from a group consisting of glass fibers, natural fibers, metal fibers, mineral fibers, carbon fibers, graphite fibers and mixtures thereof.

34. A panel, comprising:
a first layer constructed from a honeycomb web of polymer material, said first layer having a first face and a second face; and
a first facing layer connected to said first face.

35. The panel of claim 34 wherein said honeycomb web includes a first face and a second face wherein said first and second faces are opposing and said geometric shaped openings extend between and through said first and second faces.

36. The panel of claim 35, wherein said polymer material is selected from a group consisting of polyolefin, polyester, polypropylene, polyethylene, nylon, rayon, polyethylene terephthalate, polybutylene terephthalate and mixtures thereof.

37. The panel of claim 36, wherein said polymer material further includes reinforcing fibers selected from a group consisting of glass fibers, natural fibers, metal fibers, mineral fibers, carbon fibers, graphite fibers and mixtures thereof.

38. The panel of claim 34 wherein said first facing is constructed from a material selected from a group consisting of polymer facings, foils, paper type facings, fiberglass reinforced mats, EVA (ester vinyl acetate), rubber materials and highly filled layers of material around a reinforced web as well as mixtures thereof.

39. The panel of claim 34 further including a second facing layer connected to said second face.

40. The panel of claim 37 wherein said second facing is constructed from a material selected from a group consisting of polymer facings, foils, paper type facings, fiberglass reinforced mats, EVA (ester vinyl acetate), rubber materials and highly filled layers of material around a reinforced web as well as mixtures thereof.
